(19) United States
(12) Patent Application Publication
(10) Pub. No.: US 2003/0012366 A1
(43) Pub. Date: Jan. 16, 2003

(54) Interface device

(76) Inventor: Richard C Wilson, Woodbridge (GB)

Correspondence Address: Nixon & Vanderhye, 8th Floor, 1100 North Glebe Road, Arlington, VA, 22201-4714, US

(21) Appl. No.: 10/204,459

(22) PCT Filed: Feb. 22, 2001
(86) PCT No.: PCT/GB01/00761

(30) Foreign Application Priority Data
Mar. 17, 2000 (EP) 00302200.1

(51) Int. Cl. H04M 1/00; H04M 9/00

(52) U.S. Cl. 379/413.02; 379/399.01

(57) ABSTRACT

This invention provides an interface device which allows modems and other terminal equipment to be attached to almost any type of payphone. Such an interface allows data terminal equipment to be connected to the payphone (for example, for e-mail and internet access) and allows additional facilities to be added to a standard payphone.

This invention relates to an interface device for attaching data terminal equipment to a telephone network via a payphone.

There is a need for an interface device to allow modems or other terminal equipment to be attached to almost any type of payphone. Such an interface device will allow customers or the payphone operator to connect their own data terminal equipment to the payphone (for example for e-mail and internet access), or for additional facilities to be added to a standard payphone.

Ideally such an interface device should be simple, and provide security to prevent unauthorised calls being made. It is also advantageous if no software changes are required on the payphone, and ideally there should be minimal hardware interfacing.

According to the present invention there is provided an interface device for connecting data terminal equipment to a telephone network via a payphone, the interface comprising means for detecting when the payphone and the data terminal equipment are simultaneously off hook; means responsive to the detecting means for disconnecting the payphone from the telephone network and connecting the payphone to a simulated line; and means responsive to an incoming meter pulse from the telephone network for providing a corresponding meter pulse to the payphone via the simulated line.

Preferably the means for providing a corresponding meter pulse is responsive to meter pulses in the form of a pair of out of phase signals, and comprises a power supply arranged to generate a corresponding pair of out of phase signals, and a switch, and is arranged to supply said corresponding meter pulse by connecting the generated signals to the simulated line via the switch for a predetermined period of time.

Advantageously the device further comprises a multi-frequency tone detector arranged to detect multi-frequency dialling tones generated by the data terminal equipment and to generate suitable signals on a keypad interface associated with the payphone.

According to another aspect of the invention there is provided a method of connecting data terminal equipment to a telephone network via a payphone, comprising detecting when the payphone and the data terminal equipment are simultaneously off hook; upon such detection, disconnecting the payphone from the telephone networks and connecting the payphone to a simulated line; and responding to an incoming meter pulse from the telephone network to provide a corresponding meter pulse to the payphone via the simulated line.

Embodiments of the invention will now be described, by way of example only, with reference to the accompanying drawings in which:

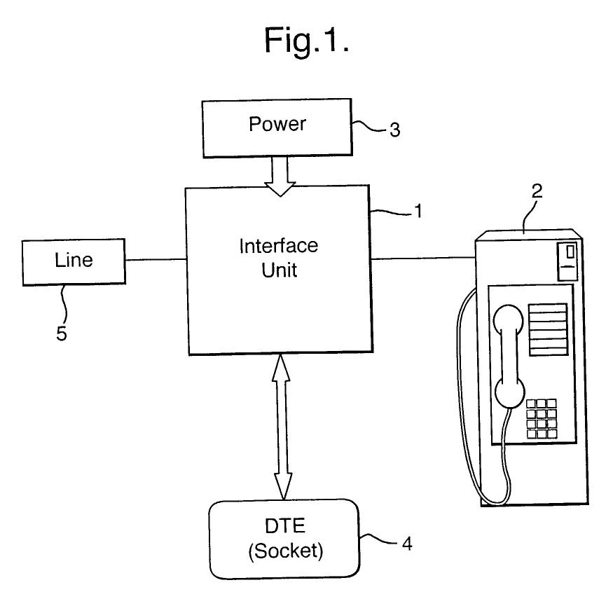

FIG. 1 is a block diagram showing how an interface device is used to connect data terminal equipment to a payphone;

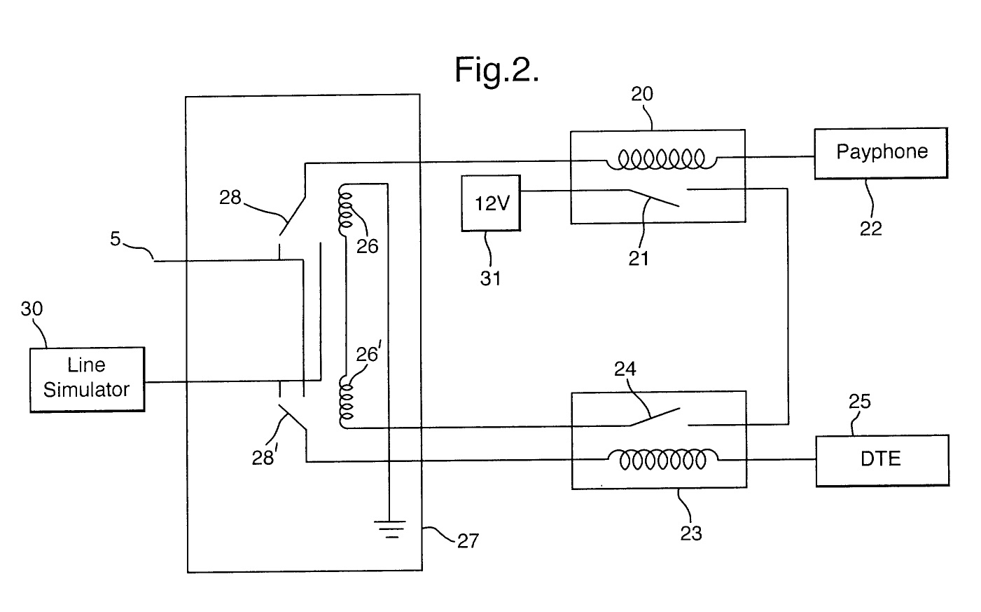

FIG. 2 is a block diagram of a changeover circuit operated using line sense relays for the data terminal equipment and the payphone;

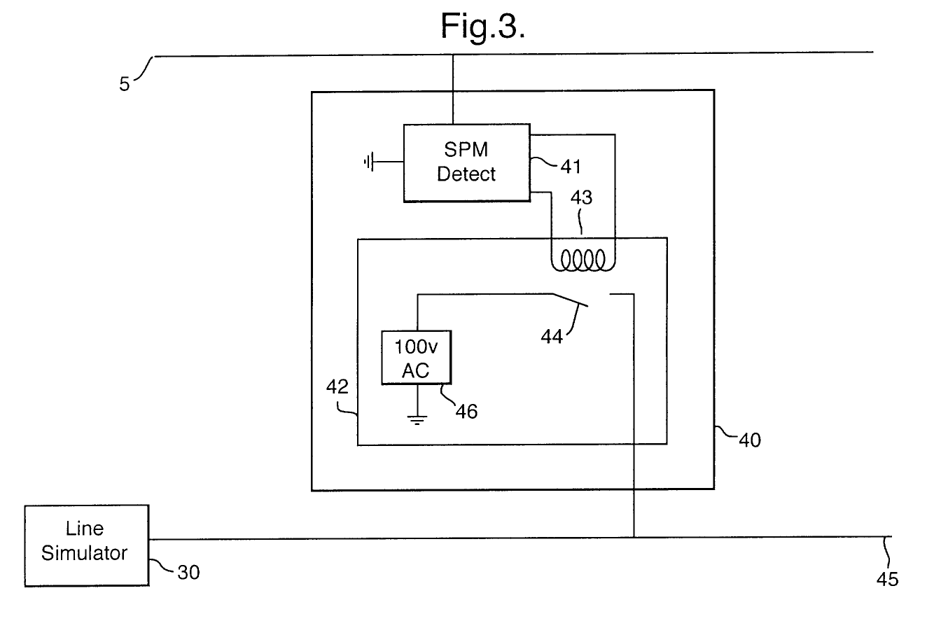

FIG. 3 is a block diagram showing a pulse regenerator;

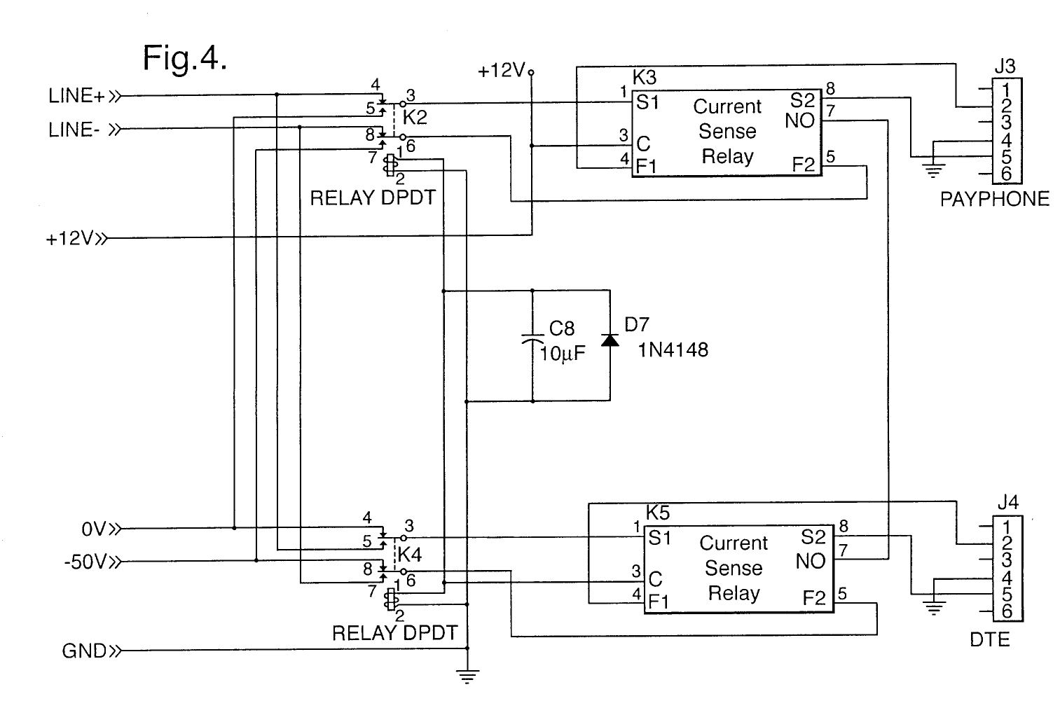

FIG. 4 is a circuit diagram illustrating an implementation of the circuit of FIG. 2;

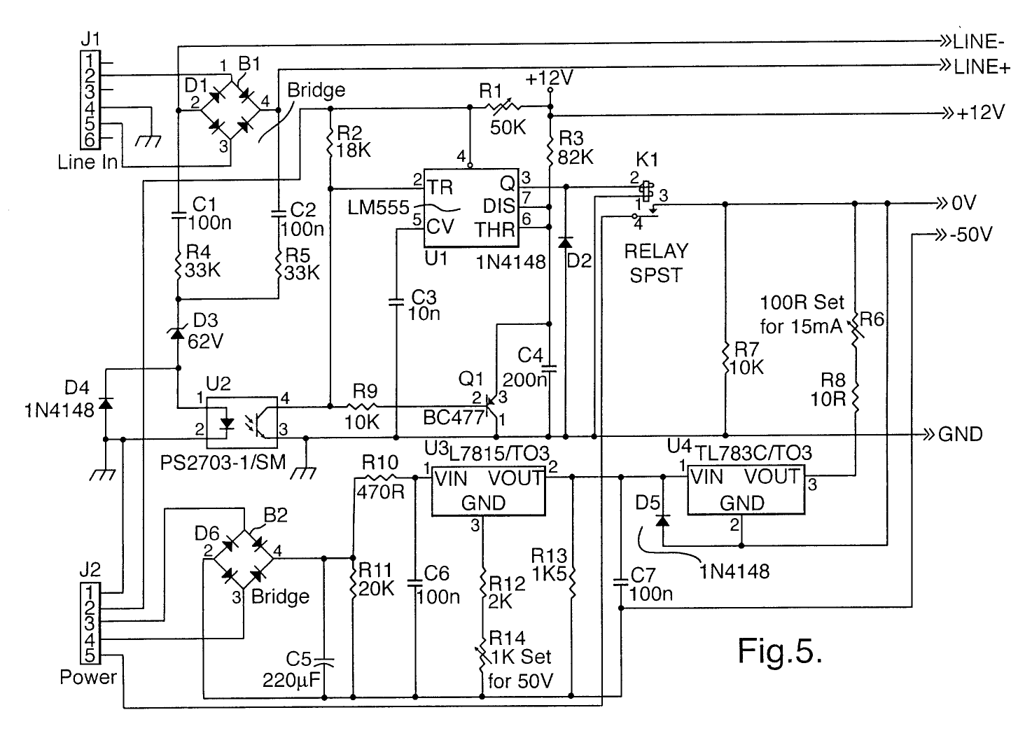

FIG. 5 is a circuit diagram illustrating an implementation of the circuit of FIG. 3;

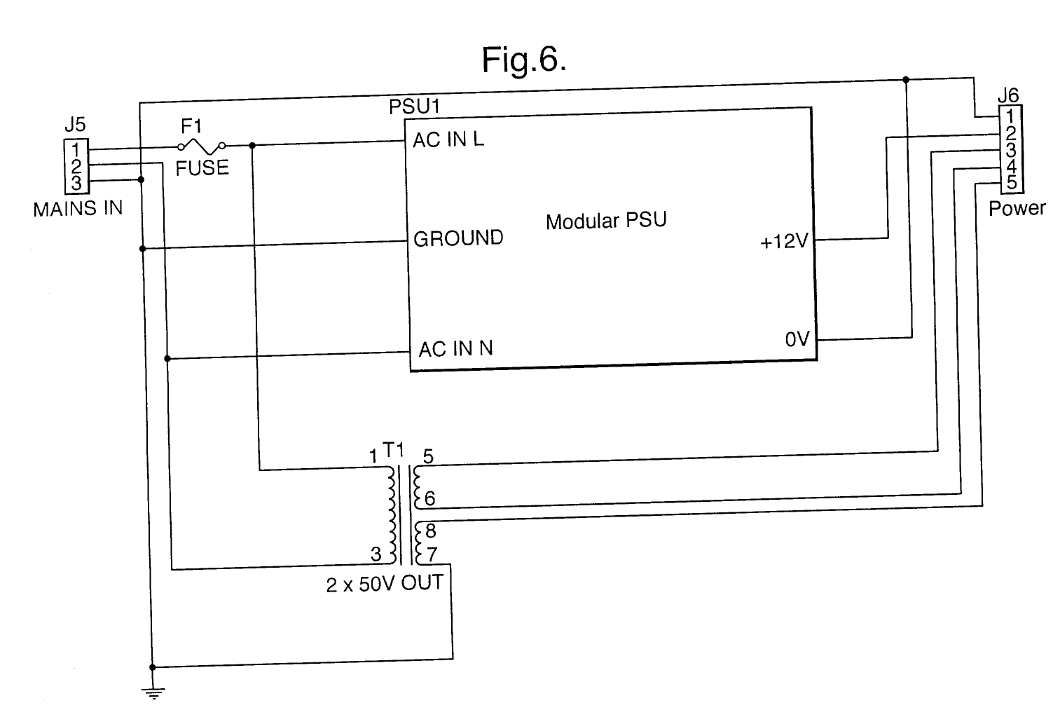

FIG. 6 is a circuit diagram showing generation of simulated metering pulses; and

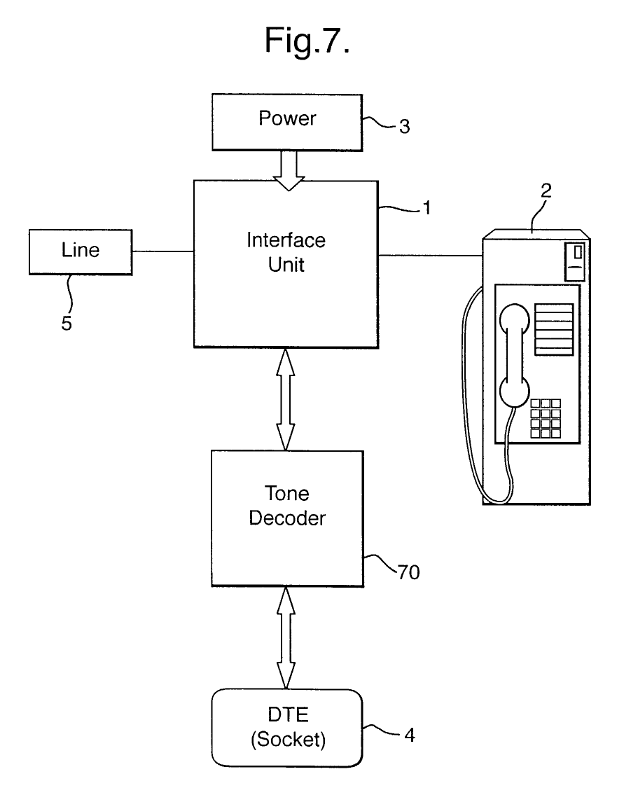

FIG. 7 is a block diagram of an interface device further comprising a tone decoding unit;

FIG. 1 shows an interface unit 1 which in use is located within a housing 2 of a payphone, but for convenience is depicted externally of the payphone housing 2. The interface unit has a power supply 3. A socket 4 is provided for the attachment of data terminal equipment (not shown in FIG. 1) to the interface unit 1. A telephone line 5 is connected to the payphone via the interface unit 1.

Referring now to FIG. 2, the interface unit 1 comprises a detector 20 connected between the payphone 22 and the telephone line 5. The detector 20 consists of a standard current sense relay which closes a switch 21 when the receiver of the payphone 22 is lifted, the payphone 22 is then said to be off-hook. The payphone 22 is then able to take payment for the call in the usual way. A similar detector 23 is connected between data terminal equipment 25 and a line simulator 30. A switch 24 is closed when the data terminal equipment 5 is off-hook. When switch 24 and 25 are closed, current flows from a power source 31 through the relays 26 and 26′, which are part of a changeover circuit 27, causing switches 28 and 28′ to operate. The payphone 22, which was originally connected to the telephone line 5 is thus connected to the line simulator 30 in order to maintain off-hook current which is required by the payphone. Similarly the data terminal equipment 25, which was originally connected to the line simulator 30, is thus connected to the telephone line 5.

Once a chargeable call is answered a meter pulse is sent to the payphone by the local exchange. The meter pulse consists of a 100V 50 Hz signal (to earth) on both the A and B wire of the telephone line 5. The meter pulse is nominally 200 mS, which is sent at intervals in dependence upon the cost of the call. The meter pulse on the A and B wire are in phase with each other, distinguishing the meter pulse from ringing current which is a 50 Hz out of phase signal on the A and B wire of the telephone line 5. As the payphone 22 is responsible for charging the correct payment for the call, this meter pulse must be detected and regenerated for use by the payphone 22. Although in this embodiment of the invention a 50 Hz metering pulse is regenerated from a received 50 Hz pulse, the invention could equally well regenerate other types of metering pulse for example a 16 kHz pulse could be regenerated, a 50 Hz pulse could be generated from a received 16 kHz pulse, or a 16 kHz pulse could be generated from a received 50 Hz pulse.

FIG. 3 shows a pulse regenerator 40 comprising a meter pulse detector 41 and a meter pulse generator 42. On detection of a meter pulse the detector 41 causes current to flow in a relay 43 which closes a switch 44 thus connecting a 100V 50 Hz power source 46 to the simulated line 45.

A call can be terminated by either the data terminal equipment 25 or the payphone 22 going on-hook, or the payphone 22 terminating the call when all call credit has expired. In the event of power failure, the system reverts to normal pay-phone only use.

Referring now to FIG. 4 which is a circuit diagram showing part of the circuit of FIG. 2 in more detail. K3 constitutes the detector 20 and K5 constitutes the detector 23. K2 and K4 constitute the changeover circuit 27. Capacitor C8 and diode D7 protect the relays from switching if voltage disturbances occur on the circuit formed when the payphone and the data terminal equipment are both off hook.

FIG. 5 is a circuit diagram showing the pulse regenerator 40 and the line simulator 30 in more detail. Firstly describing the pulse generator 40, an AC pulse on the line 5 is rectified by a bridge B1 in order to provide a positive and negative line signal at outputs 2 and 4 of the bridge B1 respectively. Capacitors C1 and C2 and resistors R4 and R5 provide a DC locking circuit. The AC components of the line signal are effectively summed at the input of a Zener diode D3. This means that if ringing current is received it will not be mistakenly detected as a meter pulse, because the out of phase ringing current signals will cancel each other out. When a signal of greater than 62V (i.e. a peak of an incoming meter pulse) is detected this will result in a signal into an optoisolator U2 (implemented using part number PS2703-1). The resultant 50 Hz pulse will trigger a retriggerable pulse monostable implemented by U1 (part number LM555), transistor Q1 and capacitor C4 producing a 200 mS pulse at output 3 of the monostable U1. A relay K1 (which constitutes the relay 43 of FIG. 3) responds to these pulses causing a simulated meter pulse to be inserted onto the simulated line 45. Moving on to describe the line simulator 30, a regulator U3 (part number L7815) together with a bridge B2, capacitors C5, C6, C7 and Resistors R10, R11, R12, R13 and R14 provide a voltage regulator which provides a stabilised 50V signal at input 1 of a current regulator U4 (part TL783C). Together the current regulator and diode D5 provide a simulated line current for use by the payphone 22 when the data terminal equipment 25 is using the telephone line 5.

Once a meter pulse is detected, a relay K1 causes a pulse corresponding to the meter pulse to be connected to the simulated line 45.

FIG. 6 is a circuit diagram detailing the generation of a meter pulse for use on the simulated line. A signal from the mains is transformed by transformer T1 into two 50V root mean square (i.e. about 75V peak to peak) signals. One of the signals is used as an input for the line simulator 30 and the other is used as an input for the pulse regenerator 40.

In some payphones, if metering pulses are received, but the payphone has not itself dialled a call the payphone will go out of service. In another embodiment of the invention the number which is called by the data terminal equipment is detected and regenerated by the payphone. FIG. 7 shows a tone decoding circuit 70 which receives a signal from the data terminal equipment 25 (see FIG. 2) and provides decoded tone signals to the interface unit 1. The tone decoding circuit 70 sends the decoded tone signals to a register in the interface unit 1, the register acting as a buffer. The interface unit is connected to a keypad interface (not shown) inside the payphone housing 2. The decoded tone signals are used to inhibit the payphone keypad and to insert dialling information received from the data terminal equipment onto the keypad interface, thus overriding the payphone keypad. The tone decoder 70 is implemented using a standard MF decoding chip such as the MITEL 8870 or SSI-202.

The advantage of this arrangement is that the payphone 22 can be “fooled” into thinking it has dialled the call and can respond accordingly without the need for reprogramming.

Automatic calls from the payphone 22 to a management system (not shown) could allow a temporary bypass route for the data terminal equipment 23 to connect to the line 5 free of charge. However, the payphone 22 will always force the data terminal equipment 25 off line in the event of a communications failure, so any call that might be attempted by the data terminal equipment would be terminated within a few seconds.

If the payphone handset is taken off-hook but no call credit is inserted into the pay phone, a call by the data terminal equipment can still be made and the call answered. However, if the call is chargeable the first metering pulse will cause the pay phone to disconnect the call by open-circuiting the line, even though the handset is still physically off-hook. This will cause the changeover circuit 27 to switch back to its original state, thus disconnecting the data terminal equipment 25 from the telephone line 5.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. An interface device for connecting data terminal equipment to a telephone network via a payphone, the interface comprising:
means for detecting when the payphone and the data terminal equipment are simultaneously off hook;
means responsive to the detecting means for disconnecting the payphone from the telephone network and connecting the payphone to a simulated line; and
means responsive to an incoming meter pulse from the telephone network for providing a corresponding meter pulse to the payphone via the simulated line.

2. An interface device according to claim 1, in which the means for providing a corresponding meter pulse is responsive to meter pulses in the form of a pair of out of phase signals, and comprises a power supply arranged to generate a corresponding pair of out of phase signals, and a switch, and is arranged to supply said corresponding meter pulse by connecting the generated signals to the simulated line via the switch for a predetermined period of time.

3. An interface device according to claim 1 or claim 2, further comprising a multi-frequency tone detector arranged to detect multi-frequency dialling tones generated by the data terminal equipment and to generate suitable signals on a keypad interface associated with the payphone.

4. A method of connecting data terminal equipment to a telephone network via a payphone, comprising:
detecting when the payphone and the data terminal equipment are simultaneously off hook;
upon such detection, disconnecting the payphone from the telephone networks and connecting the payphone to a simulated line; and
responding to an incoming meter pulse from the telephone network to provide a corresponding meter pulse to the payphone via the simulated line.
